(19) United States
(12) Patent Application Publication
(10) Pub. No.: US 2022/0268925 A1
(43) Pub. Date: Aug. 25, 2022

(54) PRESENCE DETECTION USING ULTRASONICS AND AUDIBLE SOUND

(71) Applicant: Google LLC, Mountain View, CA (US)

(72) Inventors: Christian SCHULDT, Stockholm (SE); Fredric LINDSTROM, Umea (SE); Milton RIBEIRO, New York City, NY (US); Albin FLYKT, New York City, NY (US); TJ VARGHESE, New York City, NY (US)

(73) Assignee: Google LLC, Mountain View, CA (US)

(21) Appl. No.: 17/344,552

(22) Filed: Jun. 10, 2021

Related U.S. Application Data
(60) Provisional application No. 63/152,597, filed on Feb. 23, 2021.

(51) Int. Cl. G01S 15/04; G01S 7/524; G01S 7/526; G08B 21/22; G08B 21/18; G08B 29/18; G06N 3/08

(52) U.S. Cl. CPC G01S 15/04; G01S 7/524; G01S 7/526; G08B 21/22; G08B 21/182; G08B 29/185; G06N 3/08

(57) ABSTRACT

A system includes a speaker, a microphone, a display, and one or more hardware processors coupled to the speaker, the microphone, and the display. At least one of the one or more hardware processors is operable to perform operations that include: transmitting an ultrasonic audio signal from the speaker; capturing, by the microphone, sounds in the room, wherein the sounds include an ultrasound portion and an audible portion; estimating a room impulse response based on the ultrasound portion; determining that the estimated room impulse response is different from a default room impulse response; determining, based on the audible portion, that there is non-stationary audible sound in the room; and in response to determining that the estimated room impulse response is different from the default room impulse response and that there is non-stationary audible sound in the room, switching on the display of the computing system.

### CROSS-REFERENCE TO RELATED APPLICATIONS

The present application claims priority to U.S. Provisional Patent Application No. 63/152,597, filed Feb. 23, 2021 and titled PRESENCE DETECTION USING ULTRASONICS AND AUDIBLE SOUND, the entire contents of which are hereby incorporated by reference.

### BACKGROUND

Detecting the presence of one or more people in a room is useful in many situations. For example, when people enter a conference room (e.g., that includes videoconferencing or audioconferencing equipment), it saves time and frustration when conference room equipment such as videoconferencing equipment, a display in the conference room, etc. is already active and ready for use. In another example, monitoring the room usage is helpful for scheduling or future structural/capacity planning for the room.

Keeping such equipment active all day consumes a significant amount of power and can cause the equipment to break faster than its expected lifetime. One solution is to use a camera to detect the presence of a person entering the conference room. However, this requires keeping the camera active all day and, unless the field-of-view of the camera captures the entire room, people may enter the room undetected.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computing system placed in a room includes: a speaker; a microphone; a display; and one or more hardware processors coupled to the speaker, the microphone, and the display. At least one of the one or more hardware processors may be operable to perform operations comprising: transmitting an ultrasonic audio signal from the speaker; capturing, by the microphone, sounds in the room, wherein the sounds include an ultrasound portion and an audible portion; estimating a room impulse response based on the ultrasound portion; determining that the estimated room impulse response is different from a default room impulse response; determining, based on the audible portion, that there is non-stationary audible sound in the room; and in response to determining that the estimated room impulse response is different from the default room impulse response and that there is non-stationary audible sound in the room, switching on the display of the computing system.

In some embodiments, the operation of determining that the estimated room impulse response is different from the default room impulse response includes determining that a difference between the estimated room impulse response and the default room impulse response meets a threshold or a confidence value, thereby reducing false negatives while allowing false positives. In some embodiments, determining that there is non-stationary audible sound in the room is based on the audible portion meeting a threshold noise level, thereby reducing false negatives while allowing false positives. In some embodiments, the default room impulse response is determined by measuring the default room impulse response via continuous estimation at a time when there is no movement in the room. In some embodiments, at least one of the one or more hardware processors that performs the operations is a low power processor and the operations further comprising switching on at least one other processor of the computing system in response to determining that the estimated room impulse response is different from the default room impulse response and that there is non-stationary audible sound in the room. In some embodiments, ultrasonic audio signal is a spread-spectrum signal in a range of 18-24 kHz and the audible portion is below 18 kHz. In some embodiments, the microphone includes multiple microphones, the speaker includes multiple speakers, and sounds in the room include different ultrasound portions and different audible portions. In some embodiments, the computing system is a videoconferencing system.

A computing system placed in a room includes: a speaker; a microphone; a display; and one or more hardware processors coupled to the speaker, the microphone, and the display. At least one of the one or more hardware processors may be operable to perform operations comprising: transmitting an ultrasonic audio signal from the speaker; capturing, by the microphone, sounds in the room, wherein the sounds include an ultrasound portion and an audible portion; estimating a room impulse response based on the ultrasound portion; generating, using a trained machine-learning model, an indicator of room occupancy, wherein the trained machine-learning model is a classifier that takes as input the estimated room impulse response and the audible portion; and in response to the indicator of room occupancy indicating that the room is occupied, switching on the display of the computing system.

In some embodiments, the computing system further includes a camera coupled to the one or more hardware processors, and the operations further comprise: determining whether the indicator of room occupancy is accurate, based on detecting whether an occupant is in the room based on video captured by the camera; and providing the indicator of room occupancy and whether the indicator is accurate as training input to the trained machine-learning model, wherein one or more parameters of the trained machine-learning model are automatically updated based on the training input. In some embodiments, the trained machine-learning model includes a neural network comprising a plurality of nodes and wherein operation of automatically updating the one or more parameters comprises adjusting a weight associated with one or more nodes of the plurality of nodes. In some embodiments, at least one of the one or more hardware processors that performs the operations is a low power processor and the operations further comprising switching on at least one other processor of the computing system in response to the indicator of room occupancy indicating that the room is occupied. In some embodiments, the ultrasonic audio signal is a spread-spectrum signal in a range of 18-24 kHz and the audible portion is below 18 kHz. In some embodiments, the microphone includes multiple microphones, the speaker includes multiple speakers, and sounds in the room include different ultrasound portions and different audible portions.

A computer-implemented method may comprise: instructing a speaker in a physical room to transmit an ultrasonic audio signal; receiving, from a microphone in the physical room, sounds in the physical room, wherein the sounds include an ultrasound portion and an audible portion; estimating a room impulse response based on the ultrasound portion; determining that the estimated room impulse response is different from a default room impulse response; determining, based on the audible portion, that there is non-stationary audible sound in the physical room; and in response to determining that the estimated room impulse response is different from the default room impulse response and that there is non-stationary audible sound in the physical room, increasing power flow to a conferencing component in the physical room.

In some embodiments, determining that the estimated room impulse response is different from the default room impulse response includes determining that a difference between the estimated room impulse response and the default room impulse response meets a threshold or a confidence value, thereby reducing false negatives while allowing false positives. In some embodiments, determining that there is non-stationary audible sound in the physical room is based on the audible portion meeting a threshold noise level, thereby reducing false negatives while allowing false positives. In some embodiments, the method further includes determining the default room impulse response by measuring the default room impulse response via continuous estimation at a time when there is no movement in the physical room. In some embodiments, the ultrasonic audio signal is a spread-spectrum signal in a range of 18-24 kHz and the audible portion is below 18 kHz. In some embodiments, the method further comprises switching on at least one processor in response to determining that the estimated room impulse response is different from the default room impulse response and that there is non-stationary audible sound in the physical room.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example network environment, according to some embodiments described herein.

FIG. 2A is a block diagram of an example computing device, according to some embodiments described herein.

FIG. 2B is a block diagram of an example computing device, according to some embodiments described herein.

FIG. 3 is a flowchart of an example method to determine room occupancy, according to some embodiments described herein.

FIG. 4 is a flowchart of another example method to determine room occupancy, according to some embodiments described herein.

### DETAILED DESCRIPTION

In some embodiments, a computing system placed in a physical room includes, a speaker, a microphone, a display, and a hardware processor that runs a detection application. The speaker may transmit an ultrasonic audio signal, a portion of which (including any reflections from various surfaces in the room) is captured by the microphone. When a person enters the room, the presence of the person may cause a disruption in the audio signal (including both ultrasound and audible portions) that is captured by the microphone. For example, the detection application may estimate a room impulse response that is indicative of differences between the ultrasonic audio signal transmitted by the speaker and an ultrasound portion captured by the microphone. The detection application may determine that the estimated room impulse response is different from a default room impulse response (that corresponds to a condition where the room does not have human presence).

The microphone also captures an audible portion of sounds in the room that results from a person in the room making noise (e.g., pants rustling, shoes squeaking, a chair being moved, etc.). The detection application may determine that the audible portion indicates that there is non-stationary audible sound in the room as opposed to noise from, for example, a fan running in the room, e.g., a cooling fan that is part of a computing system, an air conditioner, or other source of sound.

In response to determining that the estimated room impulse response is different from the default room impulse response and that there is non-stationary audible sound in the room, the display is switched on. In some embodiments, other devices may be switched on as well. In some embodiments, the display may provide a greeting. For example, the detection application may instruct the display to display information related to a meeting that is scheduled to occur in the room at or near the time that the person enters the room.

In some embodiments, the detection application may include a trained machine-learning model that determines an indicator of room occupancy. For example, the trained machine-learning model may be a classifier that takes the estimated room impulse response and audible portion as input.

### Network Environment 100

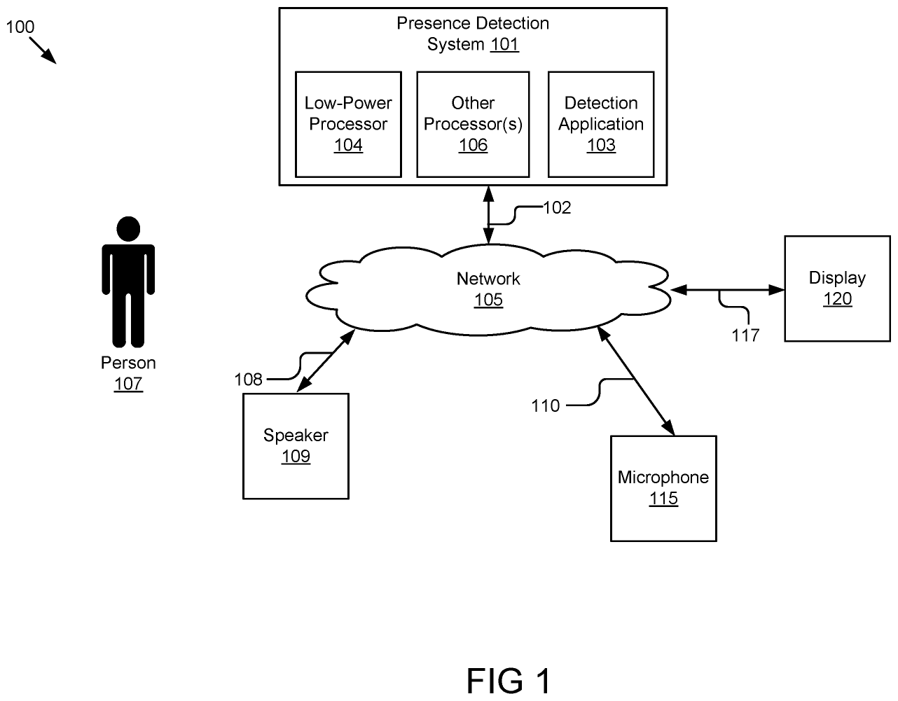

FIG. 1 illustrates a block diagram of an example environment 100. The example environment 100 may include a bounded area with network capabilities, for example, a room for conducting video conferences, a home office, a living room, a kitchen, a bedroom, etc. In different implementations, the room may be a fully enclosed space or a partially enclosed space. In some embodiments, the environment 100 includes a presence detection system 101 that stores a detection application 103, a speaker 109, a microphone 115, and a display 120. A person 107 may be present in the environment 100. In some embodiments, the presence detection system 101, the speaker 109, the microphone 115, and the display 120 may be part of a same computing system or may be distinct devices coupled via a network 105. In some embodiments, the presence detection system 101 may include a videoconferencing system such that executing the detection application 103 does not add extra computational or energy cost (or such cost is very small).

Network 105 can be any type of communication network, including one or more of the Internet, local area networks (LAN), wireless networks, switch or hub connections, etc. In some embodiments, network 105 can include peer-to-peer communication between devices, e.g., using peer-to-peer wireless protocols (e.g., Bluetooth®, Wi-Fi Direct, Ultrawideband, etc.), etc.

The speaker 109 can include hardware for generating and transmitting an ultrasonic audio signal. For example, the speaker 109 receives instructions from the detection application 103 to generate an ultrasonic audio signal. The speaker 109 generates the ultrasonic audio signal and transmits the ultrasonic audio signal. In some embodiments, the ultrasonic audio signal is a spread-spectrum signal in the range of 18-24 KHz. The speaker 109 is coupled to the network 105 via signal line 108.

The microphone 115 can include hardware for detecting and capturing sounds inside the environment 100. For example, the microphone 115 captures an ultrasound portion generated by the speaker 109 and an audible portion generated by the person 107. In some implementations, the detected audible portion is below 18 KHz. The microphone 115 may also capture audible portions of sounds generated by other objects, such as equipment that is part of the environment 100. In some embodiments, the microphone 115 is positioned far enough away from the speaker 109 and other hardware equipment that it avoids or reduces a risk of capturing audible portions created from vibrations of the hardware equipment in the room. For example, the speaker may be attached to a ceiling in the environment 100 while the microphone 115 is positioned on office equipment, e.g., on a conference room table. In some embodiments, multiple microphones 115 are used and positioned in various different locations in the environment 100 to capture different audible portions and different ultrasound portions. The microphone 115 is coupled to the network 105 via signal line 110.

The display 120 can include hardware that receives instructions from the detection application 103 to switch on and hardware for displaying graphical data. The display 120 can include any suitable display device such as a liquid crystal display (LCD), light emitting diode (LED), or plasma display screen, cathode ray tube (CRT), television, monitor, touchscreen, three-dimensional display screen, projector, or other visual display device. For example, the display 120 can be a flat display screen, multiple display screens, or a monitor screen for a computer device. The display 120 is coupled to the network 105 via signal line 117.

The presence detection system 101 includes a low-power processor 104 and one or more other processor(s) 106 coupled to the speaker 109, the microphone 115, and the display 120. The presence detection system 101 includes a detection application 103 that instructs the one or more hardware processors to perform operations including instructing the speaker 109 to transmit an ultrasonic audio signal. This occurs independent of whether a person 107 is present in the environment 100. The detection application 103 instructs the microphone 115 to capture sounds in the room. The microphone 115 captures an ultrasound portion. When a person 107 is present in the environment 100, presence of the person 107 causes a change in the room impulse response from a default room impulse response that is measured when the room is unoccupied. The person 107 also produces audible noise, which the microphone 115 captures as an audible portion.

In some embodiments, the detection application 103 estimates the room impulse response based on the ultrasound portion. The detection application 103 determines that the estimated room impulse response is different from a default room impulse response, thus indicating the presence in the room of the person 107. The detection application 103 determines, based on the audible portions, that there is non-stationary audible sound in the environment 100, which may correspond to sounds caused by the presence the person 107, e.g., the person walking around in the environment 100, pulling a chair, sitting down, or performing other actions that cause audible sound. In response to determining that the estimated room impulse response is different from the default room impulse response and that there is non-stationary audible sound in the room, the detection application 103 instructs the display 120 to switch on or instructs a conferencing component (e.g., which may be included in the same system as the presence detection system, or may be a different computer system) to increase power flow, which wakes equipment (e.g., puts the equipment in active mode) that was in a hibernate or sleep mode or completely off.

In some embodiments, the detection application 103 utilizes a trained machine-learning model that is a classifier that takes as input an estimated room impulse response and an audible portion. The detection application 103 generates, using the trained machine-learning model, an indicator of room occupancy. In response to the indicator of room occupancy indicating that the room is occupied, the detection application 103 instructs the display 120 to switch on or instructs a conferencing component in the room to increase power flow. For example, the increased power flow may be used to power a piece of equipment, such as a processor, when the piece of equipment was in sleep mode or completely off. Other pieces of equipment may include a camera and/or lights in the room, and may be turned on or activated based on the indicator of room occupancy.

For ease of illustration, FIG. 1 shows one block for the presence detection system 101, the person 107, the speaker 109, the microphone 115, and the display 120. The presence detection system 101 may represent multiple systems and the blocks can be provided in different configurations than shown. For example, the presence detection system 101 can represent multiple presence detection systems that can communicate with other presence detection systems via the network 105. In addition, the person 107, the speaker 109, the microphone 115, and the display 120 may represent any number of people 107, speakers 109, microphones 115, and/or displays 120.

### Example Computing Device 200

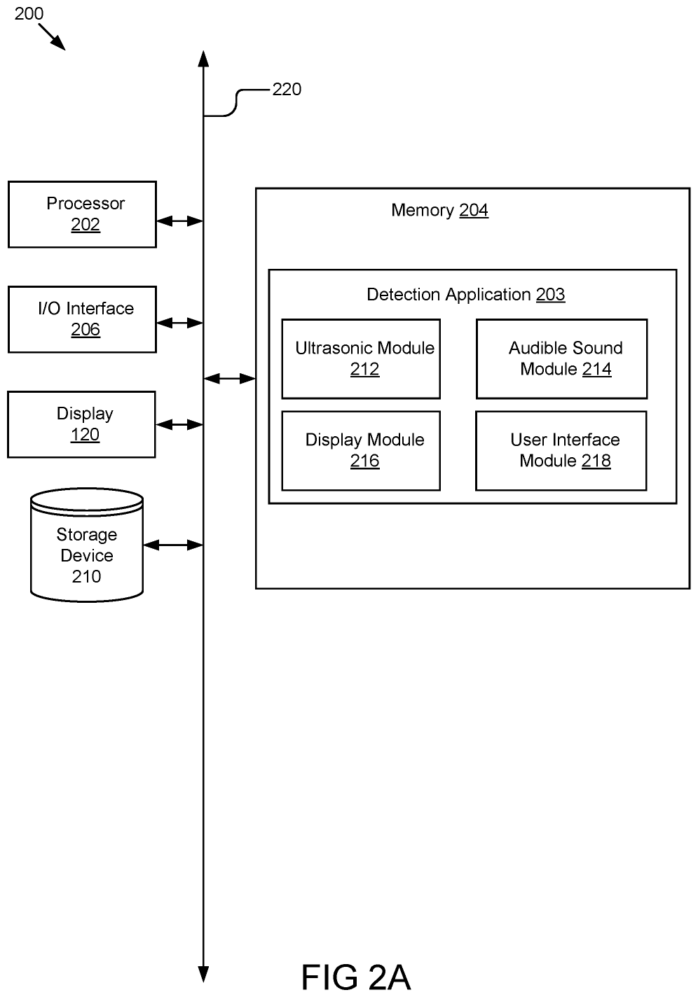

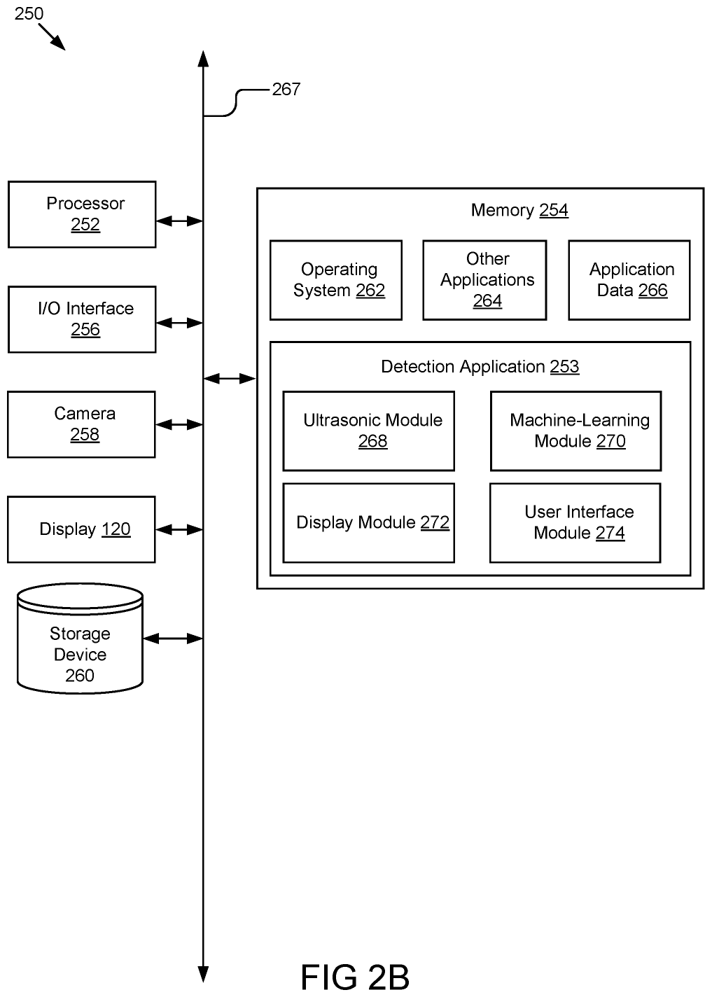

FIG. 2A is a block diagram of an example computing device 200, according to some embodiments described herein. Computing device 200 can be any suitable computer system, server, or other electronic or hardware device as described above.

In some embodiments, computing device 200 includes a processor 202, a memory 204, an input/output (I/O) interface 206, a display 120, and a storage device 210. Processor 202, memory 204, I/O interface 206, display 120, and storage device 210 may be coupled via a bus 220.

Processor 202 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 202 may include one or more co-processors that implement neural-network processing.

In some implementations, processor 202 can include one or more low-power processors or processor cores and one or more other processors or processor, e.g., that execute a detection application 203. In these implementations, the one or more low-power processors or processor cores may be operable to perform any of the methods described herein, without any of the one or more other processors being active. In some embodiments, the operations to determine that the estimated room impulse response is different from a default room impulse response and the audible portion is non-stationary audible sound in the room, and instructing a display to switch on or instructing a conferencing component to increase power flow are performed by a low power processor.

In some embodiments, processor 202 may include a processor that processes data to produce probabilistic output, e.g., the output produced by processor 202 may be imprecise or may be accurate within a range from an expected output. Processing need not be limited to a particular geographic location or have temporal limitations. For example, a processor may perform its functions in real-time (or near real-time), offline, in a batch mode, etc. A computer may be any processor in communication with a memory.

Memory 204 is typically provided in computing device 200 for access by the processor 202, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 202 and/or integrated therewith. Memory 204 can store software operating on the computing device 200 by the processor 202, including a detection application 203.

I/O interface 206 can provide functions to enable interfacing the computing device 200 with other systems and devices. Interfaced devices can be included as part of the computing device 200 or can be separate and communicate with the computing device 200. For example, network communication devices (e.g., speaker 109, microphone 115), storage devices (e.g., memory and/or database), and input/output devices can communicate via I/O interface 206. In some embodiments, the I/O interface can connect to interface devices such as input devices (keyboard, pointing device, touchscreen, microphone, camera, scanner, sensors, etc.) and/or output devices (display 120, speaker devices, printers, motors, etc.).

Some examples of interfaced devices that can connect to I/O interface 206 can include one or more display devices (e.g., display 120) that can be used to display content, e.g., images, video, and/or a user interface of an output application as described herein. Display 120 can be connected to computing device 200 via local connections (e.g., display bus) and/or via networked connections and can be any suitable display device. Display 120 was already described with reference to FIG. 1 and the description will not be repeated here.

The storage device 210 may be a non-transitory computer-readable storage medium that stores data that provides the functionality described herein. The storage device 247 may be a DRAM device, a SRAM device, flash memory or some other memory device. In some embodiments, the storage device 247 also includes a non-volatile memory or similar permanent storage device and media including a hard disk drive, a CD-ROM device, a DVD-ROM device, a DVD-RAM device, a DVD-RW device, a flash memory device, or some other mass storage device for storing information on a permanent basis.

### Example Detection Application 203

The detection application 203 of FIG. 2A may be the same as the detection application 103 of FIG. 1. The detection application 203 may include an ultrasonic module 212, an audible sound module 214, a display module 216, and a user interface module 218.

The ultrasonic module 212 estimates a room impulse response based on an ultrasound portion and determines whether the room impulse response is different from a default room impulse response. In some embodiments, the ultrasonic module 212 includes a set of instructions executable by the processor 202 (e.g., a low-power processor) to estimate the room impulse response and determine whether it is different from a default room impulse response. In some embodiments, the ultrasonic module 212 is stored in the memory 204 of the computing device 200 and can be accessible and executable by the processor 202.

In some embodiments, the ultrasonic module 212 instructs, via the I/O interface 206, the speaker 109 to transmit an ultrasonic audio signal, such as an ultrasonic spread spectrum signal that is not audible to the human ear. In some embodiments, the speaker 109 transmits periodically, for example, every millisecond, every second, every five seconds, etc. The ultrasonic audio signal bounces off objects in its path and is captured by the microphone 115. The ultrasonic module 212 may receive, via the I/O interface 206, an ultrasound portion of sounds in a room from the microphone 115. The ultrasonic module 212 determines a default room impulse response that indicates the room properties with respect to ultrasonic audio signal by the microphone 115, when the room is devoid of people. For example, the ultrasonic module 212 may calculate a time that elapsed between the speaker 109 transmitted the ultrasound audio signal to when the ultrasound portion was captured by the microphone 115 for one or more ultrasound frequencies. In some embodiments, the ultrasonic module 212 determines the default room impulse via continuous estimation at a time when there is no movement in the room.

When a person is present in the room, their body changes the ultrasonic audio signal and how it behaves in the room. For example, the person may stand in between the speaker 109 and the microphone 115 and cause a portion of ultrasonic waves to bounce off the person, bounce off of a wall, and be received by the microphone 115. In some embodiments, the ultrasonic module 212 estimates a room impulse response based on the ultrasound portion. The ultrasonic module 212 may determine that the estimated room impulse response is different from the default room impulse response. For example, the ultrasonic module 212 may use a time of flight (ToF) system by determining that the time between the speaker 109 transmitting the ultrasound audio signal and the microphone 115 capturing the ultrasound portion changes due to the presence of a person in the room. In some embodiments, the ultrasonic module 212 may use the Doppler Effect to determine that the estimated room impulse response is different from the default room impulse response.

The estimated room impulse response may be different from the default impulse response based on factors other than a person being present the room, such as temperature changes in the room or a presence of an insect or a rodent. As a result, in some embodiments, the ultrasonic module 212 applies a confidence score or a confidence percentage to the determination that the estimated room impulse response is different from the default room impulse response. For example, the ultrasonic module 212 may determine that there is a 95% likelihood (or 89%, 98%, etc.) that the estimated room impulse response is different from the default room impulse response and that the difference was caused by a person entering the room. The ultrasonic module 212 may send a confirmation to the display module 216 that the estimated room impulse response is different from the default room impulse response responsive to the likelihood meeting a threshold or a confidence value. This may advantageously reduce false negatives, which results in unnecessary wakeups, while allowing false positives. False positives result in the display 120 being woken up when not needed (i.e., no person is present), which is somewhat wasteful, but provides a good and consistent user experience of the display 120 being switched on instantly when a person is present or enters the room. As a result, appropriate threshold selection can ensure that false negatives are reduced or eliminated, while false positives may be tolerated.

A “false negative” as referred to herein is the error when the estimated room impulse response is determined to not be different from the default room impulse response, when in fact the two are different, such that the operation of switching on the display of the computing system is not triggered. A “false positive” as referred to herein is determining in error that the estimated room impulse response is different from the default room impulse response such that the operation of switching on the display of the computing system may be triggered in error. In some implementations, reducing false negatives is prioritized even when more false positives result (e.g., by adjusting the threshold to a lower value) such that there may be occasions where the display of the computing system is switched on in the absence of activity in the room (e.g., a person entering the room) and some power is wasted due to the inadvertent switching on. This may be preferable to ensure a consistent user experience where automatic switching on of the display occurs when a person enters the room (no or low number of false negatives), with a tradeoff of some inadvertent activations (false positives).

In some embodiments where there are multiple speakers 109 and/or microphones 115, the ultrasonic module 212 may determine default room impulse responses and estimated room impulse responses for different combinations of speakers and microphones. This may improve the accuracy of the determination that a person is present in the room.

The audible sound module 214 determines that there is non-stationary audible sound in the room. In some embodiments, the audible sound module 214 includes a set of instructions executable by the processor 202 to determine that there is non-stationary audible sound in the room. In some embodiments, the audible sound module 214 is stored in the memory 204 of the computing device 200 and can be accessible and executable by the processor 202.

The audible sound module 214 may receive, via the I/O interface 206, an audible portion of sounds in the room from the microphone 115. The audible sound module 214 determines whether the audible portion is a non-stationary audible sound that is produced from a person entering the room or a stationary audible sound that is produced, for example, from hardware equipment in the room. In some embodiments, the audible sound module 214 determines that the audible portion is non-stationary audible sound based on a level of sound meeting or exceeding a threshold noise level. For example, because stationary ambient background noise can be as low as 20-30 decibels in very quiet rooms, the audible sound module 214 may determine that the threshold noise level is 40 decibels and the audible portion is non-stationary audible sound because the audible portion at 60 decibels is higher than the threshold noise level of 40 decibels. In some embodiments, the audible sound module 214 transmits a confirmation that the audible portion is non-stationary audible sound responsive to the audible portion meeting the threshold noise level. This may advantageously reduce false negatives, which results in unnecessary wakeups, while allowing false positives.

The display module 216 instructs the display 120 to turn on in response to a determination that the estimated room impulse response is different from the default room impulse response and that there is non-stationary audible sound in the room. In some embodiments, the display module 216 includes a set of instructions executable by the processor 202 to instruct the display 120 to turn on. In some embodiments, the display module 216 is stored in the memory 204 of the computing device 200 and can be accessible and executable by the processor 202.

In some embodiments, the display module 216 receives a confirmation from the ultrasonic module 212 that the estimated room impulse response is different from the default room impulse response and a confirmation from the audible sound module 214 that there is non-stationary audible sound in the room. In response to receiving the confirmations, the display module 216 transmits an instruction to the display 120 to switch on or increases power flow to a conferencing component, e.g., a videoconferencing computer system or an audioconferencing computer system. For example, the increased power flow may be used to power a piece of equipment, such as a processor of the conferencing component, when the piece of equipment was in sleep mode or completely off. Other pieces of equipment may include a camera and/or lights in the room. In some embodiments, the display module 216 transmits an instruction to at least one other processor (e.g., a processor different from the processor 202 that implements the operations described above) to switch on or to increase power flow.

The user interface module 218 generates graphical data to display a user interface. In some embodiments, the user interface module 218 includes a set of instructions executable by the processor 202 to generate the graphical data. In some embodiments, the user interface module 218 is stored in the memory 204 of the computing device 200 and can be accessible and executable by the processor 202.

In some embodiments, the user interface module 218 generates graphical data to display a user interface with options to modify different settings for the detection application 203. For example, the user interface may include options for changing a confidence level for the ultrasonic module 212 to determine that the estimated room impulse response is different from a default room impulse response and options for changing a threshold noise level for the audible sound module 214 to determine that there is non-stationary audible sound in the room. In another example, the different settings may include an amount of time that the display 120 stays active in response to determining that a person is present in the room.

### Another Example Computing Device 250

FIG. 2B is a block diagram of an example computing device 250, according to some embodiments described herein. Computing device 250 can be any suitable computer system, server, or other electronic or hardware device as described above.

In some embodiments, computing device 250 includes a processor 252, a memory 254, an I/O interface 256, a camera 258, a display 120, and a storage device 260. Processor 252, memory 254, I/O interface 256, display 120, and storage device 260 may be coupled via a bus 267. The processor 252 is similar to the processor 202 in FIG. 2A and the memory 254 is similar to the memory 204 in FIG. 2A, the I/O interface 256 is similar to the I/O interface 206 in FIG. 2A, and the storage device 260 is similar to the storage device 210 in FIG. 2A, the descriptions will not be repeated here.

Camera 258 may be any type of image capture device that can capture images and/or video. In some embodiments, camera 258 may include a plurality of lenses that have different capabilities, e.g., capturing a portion of the room, all of the room, different zoom levels, image resolutions of captured images, etc. In some embodiments, the camera 258 captures images or video of the room and transmits the images and/or video to the machine-learning module 270.

Memory 254 can store software operating on the computing device 200 by the processor 252, including an operating system 262, other applications 264, application data 266, and a detection application 253.

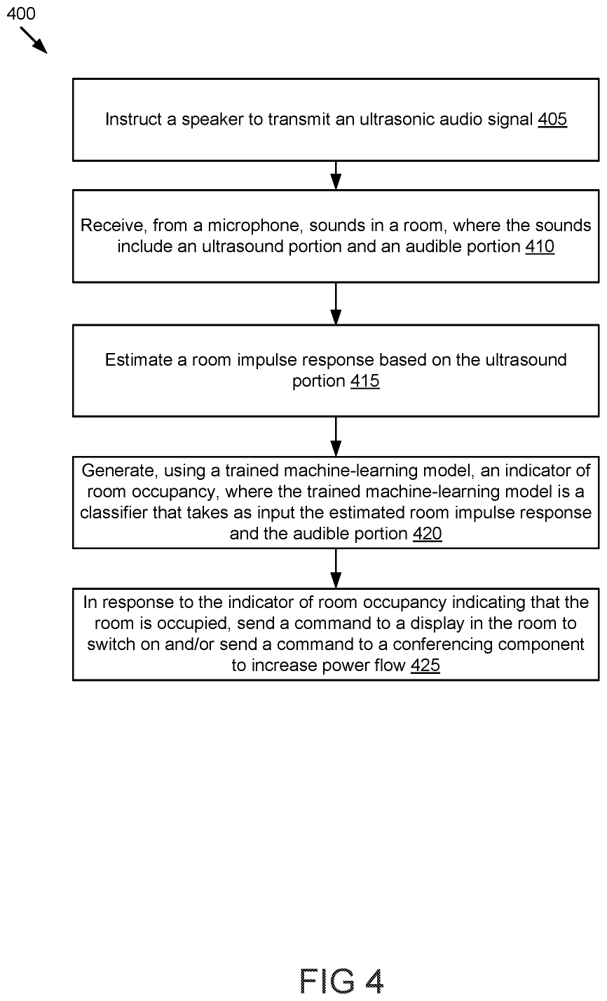

Other applications 264 may include applications such as a calendar application, a slide application, an image management application, a data display engine, a web hosting engine or application, an image display engine or application, a media display application, a communication engine, a notification engine, a social networking engine, a media sharing application, etc. One or more methods disclosed herein can operate in several environments and platforms, e.g., as a stand-alone computer program that can run on any type of computing device, as a web application having web pages, as a mobile application (“app”) run on a mobile computing device, etc. In some embodiments, the other applications 264 can each include instructions that enable processor 252 to perform functions described herein, e.g., some or all of the methods of FIG. 4.

The application data 266 may be data generated by the other applications 264 or hardware of the device 250. For example, the application data 266 may include calendar data for a calendar application, user actions identified by the other applications 264 (e.g., a social networking application), etc.

### Example Detection Application 253

The detection application 253 of FIG. 2B may be the same as the detection application 103 of FIG. 1. The detection application 253 associated with FIG. 2B may include an ultrasonic module 268, a machine-learning module 270, a display module 272, and a user interface module 274.

The ultrasonic module 268 may estimate a room impulse response based on the ultrasound portion. The particulars of how the ultrasonic module 268 estimates the room impulse response are similar to the ultrasonic module 212 discussed above with reference to FIG. 2A and so, will not be discussed here.

In some embodiments, the machine-learning module 270 includes a machine-learning model that is trained to generate an indicator of room occupancy. In some embodiments, training may be performed using supervised learning. In some embodiments, the machine-learning module 270 includes a set of instructions executable by the processor 252. In some embodiments, the machine-learning module 270 is stored in the memory 254 of the computing device 250 and can be accessible and executable by the processor 252.

In some embodiments, the machine-learning module 270 may use training data (obtained with permission for the purposes of training) to generate a trained model, specifically, a machine-learning model. For example, training data may include any type of data such as sounds (e.g., ultrasound portions and audio portions) and indications of whether the ultrasound portion and the audio portion correspond to an indicator of room occupancy (which may serve as labels for supervised learning).

For example, training data may include a training set comprising a plurality of ultrasound portions and audio portions and corresponding indicators of room occupancy, obtained with user permission. Training data may be obtained from any source, e.g., a data repository specifically marked for training, data for which permission is provided for use as training data for machine-learning, etc.

In some embodiments, the corresponding indicators of room occupancy are provided as training input to the machine-learning model along with a determination of whether the corresponding indicators are accurate based on detecting whether an occupant is in the room based on images or video captured by the camera 258. In other embodiments, the camera 258 performs the detection and transmits an indication of accuracy to the machine-learning module 270. In some embodiments, one or more parameters of the machine-learning model of the machine-learning module 270 are automatically updated based on the training input indicating whether the indicator of room occupancy is accurate.

In some embodiments, training data may include synthetic data generated for the purpose of training, such as data that is not based on activity in the context that is being trained, e.g., data generated from simulated or computer-generated images/videos, etc. In some embodiments, the machine-learning module 270 uses weights that are taken from another application and are unedited/transferred. For example, in these embodiments, the trained model may be generated, e.g., on a different device, and be provided as part of the detection application 253. In various embodiments, the trained model may be provided as a data file that includes a model structure or form (e.g., that defines a number and type of neural network nodes, connectivity between nodes and organization of the nodes into a plurality of layers), and associated weights. The machine-learning module 270 may read the data file for the trained model and implement neural networks with node connectivity, layers, and weights based on the model structure or form specified in the trained model.

The machine-learning module 270 generates a trained model that is herein referred to as a machine-learning model. In some embodiments, the machine-learning module 270 is configured to apply the machine-learning model to data, such as application data 266 (e.g., sounds), to generate an indicator of room occupancy. In some embodiments, the machine-learning module 270 may include software code to be executed by processor 252. In some embodiments, the machine-learning module 270 may specify circuit configuration (e.g., for a programmable processor, for a field programmable gate array (FPGA), etc.) enabling processor 252 to apply the machine-learning model. In some embodiments, the machine-learning module 270 may include software instructions, hardware instructions, or a combination. In some embodiments, the machine-learning module 270 may offer an application programming interface (API) that can be used by operating system 262 and/or other applications 264 to invoke the machine-learning module 270, e.g., to apply the machine-learning model to application data 266 to output the indicator of room occupancy.

In some embodiments, the machine-learning model is a classifier that takes as input the estimated room impulse response generated by the ultrasonic module 268 and the audible portion and outputs the indicator of room occupancy. Examples of classifiers include neural-networks, support vector machines, k-nearest neighbor, logistic regression, naïve bayes, decision trees, perceptron, etc.

In some embodiments, the machine-learning model may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (CNN) (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data or application data 266. Such data can include, for example, one or types of sound per node, e.g., a first node receives an ultrasound portion and a second node receives an audible portion. Subsequent intermediate layers may receive as input, output of nodes of a previous layer per the connectivity specified in the model form or structure. These layers may also be referred to as hidden layers. A final layer (e.g., output layer) produces an output of the machine-learning model. For example, the output may be an indicator of room occupancy. In some embodiments, the model form or structure also specifies a number and/or type of nodes in each layer.

In different embodiments, the machine-learning model can include one or more models. One or more of the models may include a plurality of nodes, arranged into layers per the model structure or form. In some embodiments, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. For example, the machine-learning module 270 may adjust a respective weight assigned to the estimated room impulse response and the audible portion responsive to automatically updating the one or more parameters of the machine-learning model.

In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a GPU, or special-purpose neural circuitry. In some embodiments, nodes may include memory, e.g., may be able to store and use one or more earlier inputs in processing a subsequent input. For example, nodes with memory may include long short-term memory (LSTM) nodes. LSTM nodes may use the memory to maintain state that permits the node to act like a finite state machine (FSM). Models with such nodes may be useful in processing sequential data, e.g., words in a sentence or a paragraph, a series of images, frames in a video, speech or other audio, etc. For example, a heuristics-based model used in the gating model may store one or more previously generated features corresponding to previous images.

In some embodiments, the machine-learning model may include embeddings or weights for individual nodes. For example, the machine-learning model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The machine-learning model may then be trained, e.g., using the training set of ultrasound portions and audible portions, to produce a result. In some embodiments, subsets of the total architecture may be reused from other machine-learning applications as a transfer learning approach in order to leverage pre-trained weights.

For example, training may include applying supervised learning techniques. In supervised learning, the training data can include a plurality of inputs (e.g., ultrasound portions and audible portions) and a corresponding expected output for each input (e.g., an indicator of room occupancy). Based on a comparison of the output of the machine-learning model with the expected output, values of the weights are automatically adjusted, e.g., in a manner that increases a probability that the machine-learning model produces the expected output when provided similar input.

In some embodiments, training may include applying unsupervised learning techniques. In unsupervised learning, only input data (e.g., ultrasound portions and audible portions) may be provided and the machine-learning model may be trained to differentiate data, e.g., to cluster features of the ultrasound portions and audible portions into a plurality of groups, where each group includes ultrasound portions or audible portions that are similar in some manner (e.g., are associated with a person in the room or are not associated with a person in the room).

In various embodiments, a trained model includes a set of weights, corresponding to the model structure. In embodiments where a training set of ultrasound portions and audible portions is omitted, the machine-learning module 270 may generate a machine-learning model that is based on prior training, e.g., by a developer of the machine-learning module 270, by a third-party, etc. In some embodiments, the machine-learning model may include a set of weights that are fixed, e.g., downloaded from a server that provides the weights.

In some embodiments, the machine-learning module 270 may be implemented in an offline manner. In these embodiments, the machine-learning model may be generated in a first stage and provided as part of the machine-learning module 270. In some embodiments, small updates of the machine-learning model may be implemented in an online manner. In such embodiments, an application that invokes the machine-learning module 270 (e.g., operating system 262, one or more of other applications 264, etc.) may utilize the indicator of occupancy produced by the machine-learning module 270 and transmit the indication of occupancy to the display module 272 so that the display module 272 transmits an instruction to the display 120 to switch on or instructs a conferencing component to increase power flow. In some embodiments, e.g., when the conferencing component is switched off, increasing the power flow may include increasing power supplied from a zero value. In some embodiments, e.g., when the conferencing component is in sleep or hibernate mode, increasing the power flow may include increasing power supplied from a low value for the sleep or hibernate mode to a higher value for an active mode of usage of the conferencing component. The machine-learning module 270 may also generate system logs periodically, e.g., hourly, monthly, quarterly, etc. and may be used to update the machine-learning model, e.g., to update embeddings for the machine-learning model.

In some embodiments, the machine-learning module 270 may be implemented in a manner that can adapt to a particular configuration of computing device 250 on which the machine-learning module 270 is executed. For example, the machine-learning module 270 may determine a computational graph that utilizes available computational resources, e.g., processor 252. For example, if the machine-learning module 270 is implemented as a distributed application on multiple devices, the machine-learning module 270 may determine computations to be carried out on individual devices in a manner that optimizes computation. In another example, the machine-learning module 270 may determine that processor 252 includes a GPU with a particular number of GPU cores (e.g., 1000) and implement the machine-learning module 270 accordingly (e.g., as 1000 individual processes or threads).

In some embodiments, the machine-learning module 270 may implement an ensemble of trained models. For example, the machine-learning model may include a plurality of trained models that are each applicable to the same input data. In these embodiments, the machine-learning module 270 may choose a particular trained model, e.g., based on available computational resources, success rate with prior inferences, etc.

In some embodiments, the machine-learning module 270 may execute a plurality of trained models. In these embodiments, the machine-learning module 270 may combine outputs from applying individual models, e.g., using a voting-technique that scores individual outputs from applying each trained model, or by choosing one or more particular outputs. In some embodiments, such a selector is part of the model itself and functions as a connected layer in between the trained models. Further, in these embodiments, the machine-learning module 270 may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning module 270, e.g., by operating system 262 or one or more applications 264.

The user interface module 274 may be similar to the user interface module 218 of FIG. 2A and so the description will not be repeated here.

### Example Method 300

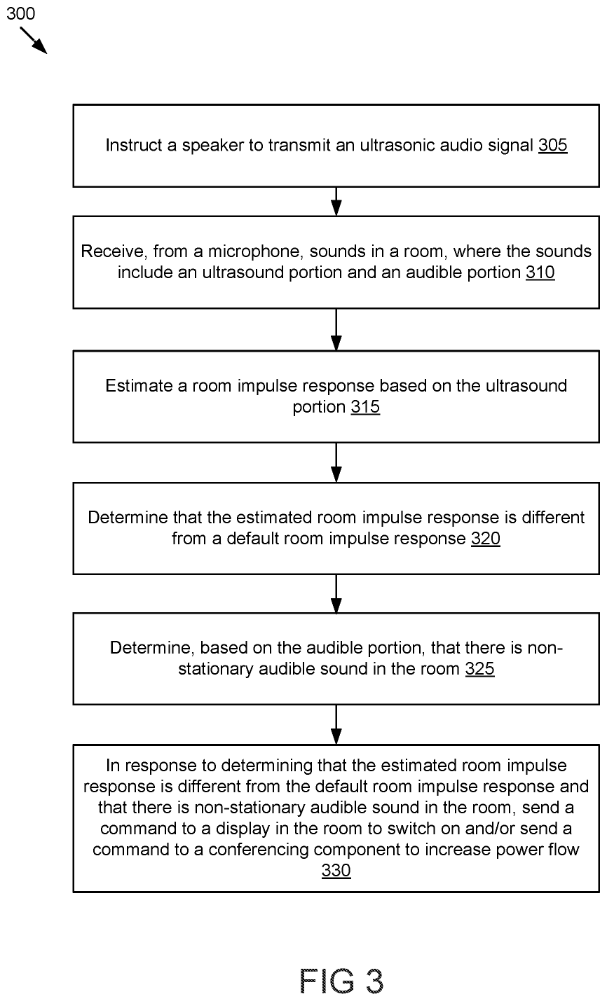

FIG. 3 is a flowchart of an example method to determine room occupancy. The method 300 is performed by the detection application 203 stored on the computing device 200.

Method 300 may begin at block 305. At block 305, a speaker is instructed to transmit an ultrasonic audio signal. For example, the speaker 109 transmits an ultrasonic audio signal that is a spread-spectrum signal in a range of 18-24 kHz. Block 305 may be followed by block 310.

At block 310, sounds in a room as detected by a microphone are received from the microphone, where the sounds include an ultrasound portion and an audible portion. For example, the microphone 115 detects an audible portion that is below 18 kHz. Block 310 may be followed by block 315.

At block 315, a room impulse response is estimated based on the ultrasound portion. Block 315 may be followed by block 320.

At block 320, the estimated room impulse response is determined to be different from a default room impulse response. The default room impulse response may be determined by prior measurement of the room impulse via continuous estimation at a time when there is no movement in the room. The estimated room impulse may be determined to be different from the default room impulse based on determining that a difference between the estimated room impulse response and the default room impulse response meets a threshold or a confidence value. Block 320 may be followed by block 325.

At block 325, it may be determined, based on the audible portion, that there is non-stationary audible sound in the room. For example, the audible portion may be determined to be non-stationary audible sound in the room based on the audible portion meeting a threshold noise level. Block 325 may be followed by block 330.

At block 330, in response to determining that the estimated room impulse response is different from the default room impulse response and that there is non-stationary audible sound in the room, a command is sent to a display in the room to switch on and/or a command is sent to a conferencing component in the room to increase power flow, e.g., to switch from a hibernate or sleep mode to an active mode. For example, a display 120 is switched on to display a greeting or calendar information for a meeting scheduled in the room at or near the time that the change in the room impulse response and the presence of non-stationary audible sound is detected.

Method 300 or portions thereof may be performed periodically, e.g., once every second, once every 5 seconds, once a minute, etc. to automatically switch on the display 120 when the specified conditions (the estimated room impulse response being different from the default room impulse response and detection of non-stationary audible sound in the room) are met. In some implementations, method 300 may be implemented by a low-power processor and/or a dedicated circuit, such that method 300 can be performed at a low energy cost, and while other parts of a computing system (e.g., a conferencing component or system) that includes the low-power processor are inactive (e.g., in power saving mode).

FIG. 4 is a flowchart of another example method to determine room occupancy. The method 400 is performed by the detection application 253 stored on the computing device 250.

Method 400 may begin at block 405. At block 405, a speaker installed in a room is instructed to transmit an ultrasonic audio signal. For example, the speaker 109 transmits an ultrasonic audio signal that is a spread-spectrum signal in a range of 18-24 kHz. Block 405 may be followed by block 410.

At block 410, sounds in a room as detected by a microphone in the room are received from the microphone, where the sounds include an ultrasound portion and an audible portion. For example, the microphone 115 detects an audible portion that is below 18 kHz. Block 410 may be followed by block 415.

At block 415, a room impulse response is estimated based on the ultrasound portion. Block 415 may be followed by block 420.

At block 420, a trained machine-learning model generates an indicator of room occupancy, where the trained machine-learning model is a classifier that takes as input the estimated room impulse response and the audible portion. Block 420 may be followed by block 425.

At block 425, in response to the indicator of room occupancy indicating that the room is occupied, a command is sent to a display in the room (e.g., display 120) to switch on and/or a command is sent to a conferencing component to increase power flow, e.g., to switch from a hibernate or sleep mode to an active mode.

Method 400 or portions thereof may be performed periodically, e.g., once every second, once every 5 seconds, once a minute, etc. to automatically switch on the display 120 when the specified conditions (the estimated room impulse response being different from the default room impulse response and detection of non-stationary audible sound in the room) are met. In some implementations, method 400 may be implemented by a low-power processor and/or a dedicate circuit, such that method 400 can be performed at a low energy cost, and while other parts of a computing system that includes the low-power processor are inactive (e.g., in power saving mode).

In situations in which the systems and methods discussed herein may collect or use personal information about users (e.g., user data, information about a user's social network, a user's location, a user's biometric information, a user's activities and/or demographic information, storage and analysis of video by the detection application 103, etc.), users are provided with opportunities to control whether personal information is collected, whether the personal information is stored, whether the personal information is used, whether the images or videos are analyzed, and how information about the user is collected, stored, and used. That is, the systems and methods discussed herein may collect, store, and/or use user personal information only upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity information may be treated, e.g., anonymized, so that no personally identifiable information can be determined from a video. As another example, a user's geographic location may be generalized to a larger region so that the user's particular location cannot be determined.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computing system placed in a room, the computing system comprising:
a speaker;
a microphone;
a display; and
one or more hardware processors coupled to the speaker, the microphone, and the display, at least one of the one or more hardware processors operable to perform operations comprising:
transmitting an ultrasonic audio signal from the speaker;
capturing, by the microphone, sounds in the room, wherein the sounds include an ultrasound portion and an audible portion;
estimating a room impulse response based on the ultrasound portion;
determining that the estimated room impulse response is different from a default room impulse response;
determining, based on the audible portion, that there is non-stationary audible sound in the room; and
in response to determining that the estimated room impulse response is different from the default room impulse response and that there is non-stationary audible sound in the room, switching on the display of the computing system.

2. The computing system of claim 1, wherein the operation of determining that the estimated room impulse response is different from the default room impulse response includes determining that a difference between the estimated room impulse response and the default room impulse response meets a threshold or a confidence value, thereby reducing false negatives while allowing false positives.

3. The computing system of claim 1, wherein determining that there is non-stationary audible sound in the room is based on the audible portion meeting a threshold noise level, thereby reducing false negatives while allowing false positives.

4. The computing system of claim 1, wherein the default room impulse response is determined by measuring the default room impulse response via continuous estimation at a time when there is no movement in the room.

5. The computing system of claim 1, wherein at least one of the one or more hardware processors that performs the operations is a low power processor and the operations further comprising switching on at least one other processor of the computing system in response to determining that the estimated room impulse response is different from the default room impulse response and that there is non-stationary audible sound in the room.

6. The computing system of claim 1, wherein the ultrasonic audio signal is a spread-spectrum signal in a range of 18-24 kHz and the audible portion is below 18 kHz.

7. The computing system of claim 1, wherein the microphone includes multiple microphones, the speaker includes multiple speakers, and sounds in the room include different ultrasound portions and different audible portions.

8. The computing system of claim 1, wherein the computing system is a videoconferencing system.

9. A computing system in a room, the computing system comprising:
a speaker;
a microphone;
a display; and
one or more hardware processors coupled to the speaker, the microphone, and the display, at least one of the one or more hardware processors operable to perform operations comprising:
transmitting an ultrasonic audio signal from the speaker;
capturing by the microphone, sounds in the room, wherein the sounds include an ultrasound portion and an audible portion;
estimating a room impulse response based on the ultrasound portion;
generating, using a trained machine-learning model, an indicator of room occupancy, wherein the trained machine-learning model is a classifier that takes as input the estimated room impulse response and the audible portion; and
in response to the indicator of room occupancy indicating that the room is occupied, switching on the display of the computing system.

10. The computing system of claim 9, wherein the computing system further includes a camera coupled to the one or more hardware processors, and wherein the operations further comprise:
determining whether the indicator of room occupancy is accurate, based on detecting whether an occupant is in the room based on video captured by the camera; and
providing the indicator of room occupancy and whether the indicator is accurate as training input to the trained machine-learning model, wherein one or more parameters of the trained machine-learning model are automatically updated based on the training input.

11. The computing system of claim 10, wherein the trained machine-learning model includes a neural network comprising a plurality of nodes and wherein operation of automatically updating the one or more parameters comprises adjusting a weight associated with one or more nodes of the plurality of nodes.

12. The computing system of claim 9, wherein at least one of the one or more hardware processors that performs the operations is a low power processor and the operations further comprising switching on at least one other processor of the computing system in response to the indicator of room occupancy indicating that the room is occupied.

13. The computing system of claim 9, wherein the ultrasonic audio signal is a spread-spectrum signal in a range of 18-24 kHz and the audible portion is below 18 kHz.

14. The computing system of claim 9, wherein the microphone includes multiple microphones, the speaker includes multiple speakers, and sounds in the room include different ultrasound portions and different audible portions.

15. A computer-implemented method comprising:
instructing a speaker in a physical room to transmit an ultrasonic audio signal;
receiving, from a microphone in the physical room, sounds in the physical room, wherein the sounds include an ultrasound portion and an audible portion;
estimating a room impulse response based on the ultrasound portion;
determining that the estimated room impulse response is different from a default room impulse response;
determining, based on the audible portion, that there is non-stationary audible sound in the physical room; and
in response to determining that the estimated room impulse response is different from the default room impulse response and that there is non-stationary audible sound in the physical room, increasing power flow to a conferencing component in the physical room.

16. The method of claim 15, wherein determining that the estimated room impulse response is different from the default room impulse response includes determining that a difference between the estimated room impulse response and the default room impulse response meets a threshold or a confidence value, thereby reducing false negatives while allowing false positives.

17. The method of claim 15, wherein determining that there is non-stationary audible sound in the physical room is based on the audible portion meeting a threshold noise level, thereby reducing false negatives while allowing false positives.

18. The method of claim 15, further comprising determining the default room impulse response by measuring the default room impulse response via continuous estimation at a time when there is no movement in the physical room.

19. The method of claim 15, wherein the ultrasonic audio signal is a spread-spectrum signal in a range of 18-24 kHz and the audible portion is below 18 kHz.

20. The method of claim 15, further comprising switching on at least one processor in response to determining that the estimated room impulse response is different from the default room impulse response and that there is non-stationary audible sound in the physical room.
